(19) United States
(12) Patent Application Publication
(10) Pub. No.: US 2021/0337795 A1
(43) Pub. Date: Nov. 4, 2021

(54) COMPOSITIONS FOR IMPROVING AGRICULTURAL PRODUCTION

(71) Applicant: Environmental Services Pty Ltd, Thomastown (AU)

(72) Inventor: Kevin Joyce, Thomastown (AU)

(73) Assignee: Environmental Services Pty Ltd, Thomastown (AU)

(21) Appl. No.: 17/241,345

(22) Filed: Apr. 27, 2021

(30) Foreign Application Priority Data
Apr. 30, 2020 (AU) 2020901369

(51) Int. Cl. A01N 37/42; A01N 31/02; A01N 65/36; A01N 25/02

(52) U.S. Cl. CPC A01N 37/42; A01N 25/02; A01N 65/36; A01N 31/02

(57) ABSTRACT

According to the present invention there is provided a composition for enhancing effect of agricultural additives wherein the composition comprises at least one bioflavonoid and at least one plant growth regulator. Preferably, the composition includes at least one organic acid. Preferably, the at least one organic acid is naturally produced. More preferably, the at least one bioflavonoid is a natural plant extract. The composition is preferably in the form of a liquid. Preferably, the composition is present at between 0.25 to 4.0 ml in a topical composition per 1 litre of water or other diluting agent. The topical composition may be suitable for use as a plant foliar spray. The topical composition may also be suitable for dispensing via an irrigation system. The topical composition can also be suitable for application as a seed coating.

### FIELD OF THE INVENTION

This invention relates to compositions for enhancing the effectiveness of agricultural additives such as plant growth regulators.

### BACKGROUND OF THE INVENTION

With an ever increasing population and stresses of climate change, there is pressure to increase agricultural production for purposes including food, animal fodder and fuel.

One method of increasing agricultural production is to develop new varieties by selective breeding and/or introduce artificial genetic changes to crop plants. Unfortunately, these methods can also involve an increasing failure rate of seed germination, and a lack of ongoing plant development.

Plant growth regulators, also known as plant hormones, have been used to increase crop and plant production however these are expensive and require careful application.

Furthermore, traditional agricultural treatments such as pesticides, herbicides or nutrients such as fertilizers have been found to have undesirable side-effects on those ingesting them and therefore there is also pressure to seek less harmful alternatives from consumers. The traditional agricultural treatments, together with other farming methods such as tilling and environment stress from climate due to environment extremes, have been found to cause stress on the soils which consequently also reduce agricultural production.

Examples of the invention seek to solve or at least ameliorate one or more disadvantages of previous agricultural practices including reduce or eliminate use of agricultural treatments or reduce costs of agricultural production or to desirably increase agricultural production.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### SUMMARY OF THE INVENTION

According to the present invention there is provided a composition for enhancing effect of agricultural additives wherein the composition comprises at least one bioflavonoid and at least one plant growth regulator.

Preferably, the composition includes at least one organic acid. Preferably, the at least one organic acid is naturally produced. More preferably, the at least one bioflavonoid is a natural plant extract.

The composition is preferably in the form of a liquid. Preferably, the composition is present at between 0.25 to 4.0 ml in a topical composition per 1 litre of water or other diluting agent. The topical composition may be suitable for use as a plant foliar spray. The topical composition may also be suitable for dispensing via an irrigation system. The topical composition can also be suitable for application as a seed coating.

In a preferred embodiment, the composition comprises:

between 10% to 20% (by weight) at least one bioflavonoid; and

between 10% to 20% (by weight) at least one plant growth regulator.

Preferably, the composition includes between 30% to 60% (by weight) of at least one organic acid.

In a most preferred embodiment, the composition comprises:

between 10% to 25% (by weight) at least one bioflavonoid which is naturally extracted; and

between 10% to 20% (by weight) at least one plant growth regulator; and/or

between 30% to 60% (by weight) at least one naturally produced organic acid.

The composition may include the at least one plant growth regulator is selected from the group including: auxins, cytokinins, gibberellins, abscisic acid and triacontanol.

The at least one bioflavonoid may be selected from the group including: citrus fruit plant extracts, including grapefruit, lemon, pomelo, lime, orange, tangerine, bitter orange extract.

The at least one organic acid may be selected from the group including: malic acid, citric acid, lactic acid, salicylic acid, Silicic acid, Ascorbic acid, caprylic acid and tartaric acid.

The composition may include agricultural additives including wetting agents or fungicides. The wetting agent may be selected from the group including: Saponins glycerine.

### DETAILED DESCRIPTION OF THE INVENTION

Preferred embodiments of the present invention are directed to compositions for the general improvement of agricultural production and in particular for enhancing effect of at least one plant growth regulator. When the compositions comprise at least one growth regulator and at least one bioflavonoid, the plant development and/or production is substantially enhanced over what would have been expected from application of the same amount of at least one plant growth regulator alone.

As plant growth regulators are expensive, the applicant has found that surprisingly the compositions reduce the cost of the applications yet enhance the effect of the plant growth regulators to deliver the same or better results at lower doses of added plant growth regulators (such as plant hormones). The invention thus desirably gains the benefits of expensive plant growth regulators without incurring the full costs typically associated with the results required. In particular, the applicant considers that the at least one bioflavonoid stimulates critical plant processes to enhance the action of the plant growth regulator.

Plant growth regulators (such as plant hormones) are commonly used in crop and plant production. They are chemicals found naturally in plants or synthesised artificially which effect the growth of targeted areas of plant cells or tissues.

Common plant growth regulators include:

Auxins: Stimulate cell elongation

Cytokinins: Stimulate cell division and induce shoot bud formation

Gibberellins: Cause stem elongation and flowering

Abscisic Acid: Primarily involved in regulating seed germination.

Triacontanol: Effects cell division and improves photosynthesis.

The compositions can comprise one plant growth regulator but more preferably includes at least two or more plant growth regulators.

The composition also preferably includes at least one organic acid, which the applicant considers to enhance absorption of the at least one plant growth regulator by the plants. It is preferred that the at least one bioflavonoid and the at least one organic acid are natural plant extracts or naturally produced elements.

In a preferred embodiment, the composition is in a liquid form which is able to be easily produced into a topical composition by being diluted with a diluting agent such as water.

In a particularly preferred embodiment, the composition comprises:

between 10% to 25% (by weight) at least one bioflavonoid; and

between 10% to 20% (by weight) at least one plant growth regulator.

Preferably, the composition between 30% to 60% (by weight) at least one organic acid. More preferably, the at least one bioflavonoid is a naturally extract bioflavonoid. More preferably, the at least one organic acid is naturally produced.

Preferably, the composition is present in the topical composition at between 0.25 ml to 4 ml per litre of diluting agent such as water. However the dilution can vary, as would be understood by a person skilled in the art, depending on different factors such as soil condition, foliage cover, growth rate, crop type, weather, water used per hectare etc. The topical composition can be applied as a plant foliar spray on the roots, stems or leaves, as a liquid seed coating or as an irrigation additive such as those dispensable via a drip or spray system.

The applicant considers that the treatment of the composition on the foliar of the plant provides the advantage of stimulating production of bioflavonoids and plant growth regulators by the plant which are needed for the process of secondary metabolism in plants where the plants are not able to adequately produce these compounds due to the effects of abiotic or biotic stress conditions.

The applicant has found that this composition for enhancing effect of plant growth regulators can be used on various food crops such as vegetables, fruit and nut trees, turf, and broad acre crops such as canola, soy and wheat. Improved assimilation and utilisation of at least one plant growth regulator provides the chance to lower the required amount of plant growth regulators such as plant hormones by capitalising on the plant's own metabolic processes to take full advantage thereby improving the plant growth and production, in particular for food crops.

The at least one bioflavonoid may be selected from the group including: citrus fruit plant extracts, including grapefruit, lemon, lime, orange, pomelo, tangerine, bitter orange extract.

The at least one organic acid may be selected from the group including: malic acid, citric acid, lactic acid, salicylic acid, caprylic acid Silicic acid, Ascorbic acid, and tartaric acid.

In a particularly preferred embodiment, the compositions mentioned above can include other additives including wetting agents and fungicides.

The wetting agent may be selected from the group including: Saponins, glycerine.

Through-out the specification and claims the word “comprise” and its derivatives is intended to have an inclusive rather than exclusive meaning unless the context requires otherwise.

It will be appreciated by those skilled in the art that many modifications and variations may be made to the methods of the invention described herein without departing from the spirit and scope of the invention.

1. A composition for enhancing effect of agricultural additives wherein the composition comprises:
at least one bioflavonoid; and
at least one plant growth regulator.

2. A composition according to claim 1, including at least one organic acid.

3. A composition according to claim 2, wherein the at least one organic acid is naturally produced.

4. A composition according to claim 2, wherein the at least one bioflavonoid is a natural plant extract.

5. A composition according to claim 2 being in the form of a liquid.

6. A composition according to claim 5 wherein the composition is present in a topical composition at between 0.25 to 4.0 ml per litre of water or other diluting agent.

7. A composition according to claim 6 wherein the topical composition is suitable for use as a plant foliar spray.

8. A composition according to claim 6 wherein the topical composition is suitable for dispensing via an irrigation system.

9. A composition according to claim 6, wherein the topical composition is suitable for application as a seed coating.

10. A composition according to claim 2, comprising:
between 10% to 20% (by weight) at least one bioflavonoid; and
between 10% to 20% (by weight) at least one plant growth regulator.

11. A composition according to claim 10, including between 30% to 60% (by weight) at least one organic acid.

12. A composition according to claim 10, comprising:
between 10% to 20% (by weight)) at least one bioflavonoid which is a natural plant extract; and
between 10% to 20% (by weight) at least one plant growth regulator; and/or
between 30% to 60% (by weight)) at least one organic acid which is naturally produced.

13. A composition according to claim 2, including the at least one plant growth regulator selected from the group consisting of: auxins, cytokinins, gibberellins, abscisic acid and triacontanol.

14. A composition according to claim 2, wherein the at least one bioflavonoid is selected from the group including: citrus fruit plant extracts, including grapefruit, lemon, lime, orange, tangerine, pomelo, bitter orange extract.

15. A composition according to claim 2, wherein the at least one organic acid is selected from the group consisting of: malic acid, Silicic acid, Ascorbic acid, citric acid, lactic acid, salicylic acid, caprylic acid and tartaric acid.

16. A composition according to claim 2, wherein the composition includes additives including wetting agents or fungicides.
